(19) United States
(12) Patent Application Publication
(10) Pub. No.: US 2016/0160557 A1
(43) Pub. Date: Jun. 9, 2016

(54) SMART WINDOW USING AEROGEL

(71) Applicants: HYUNDAI MOTOR COMPANY, Seoul (KR); KIA MOTORS CORPORATION, Seoul (KR); INDUSTRY ACADEMY COOPERATION FOUNDATION OF SEJONG UNIVERSITY, Seoul (KR)

(72) Inventors: Hyun Sub KIM, Seoul (KR); Nak Kyoung KONG, Seongnam-si (KR); Young Sub OH, Suwon-si (KR); Jin Hee LEE, Seoul (KR); Yong Ho SEO, Seoul (KR)

(21) Appl. No.: 14/873,130

(22) Filed: Oct. 1, 2015

(30) Foreign Application Priority Data
Dec. 3, 2014 (KR) 10-2014-0172482

(51) Int. Cl. E06B 9/24; G02F 1/1343; G02F 1/137

(52) U.S. Cl. CPC E06B 9/24; G02F 1/137; G02F 1/13439; G02F 2001/13756; E06B 2009/2464

(57) ABSTRACT

A smart window includes a pair of transparent electrodes spaced apart to face each other. Porous aerogel is interposed between the pair of transparent electrodes. Liquid crystal is interposed between the pair of transparent electrodes and filliping pores of the aerogel. The smart window scatters more light because an interface between the aerogel and liquid crystal is maximized by filling pores of the aerogel with the liquid crystal.

### CROSS-REFERENCE TO RELATED APPLICATION

This application claims under 35 U.S.C. §119(a) the benefit of priority to Korean Patent Application No. 10-2014-0172482 filed Dec. 3, 2014, the entire content of which is incorporated herein by reference.

### TECHNICAL FIELD

The present disclosure relates to a smart window using aerogel. More particularly, the present disclosure relates to a smart window, which uses aerogel having has high porosity, scatters more light because an interface between the aerogel and liquid crystal is maximized, and thus achieves a high light blocking rate and a low driving voltage.

### BACKGROUND

In the automotive industry, advanced technologies in machinery, electronics, chemistry, energy and environment fields are integrated. In recent years, high efficiency, safety, and convenience have become more important as reinforcement of environment regulation and privacy protection and quality of life increases. As an example, a smart window technology, which can improve energy efficiency and satisfy sensitivity and functionality, is drawing big attention.

The smart window technology refers to an active control technology, which can reduce energy loss and provide pleasant environment to customers by controlling transmittance of light introduced from outside. The active control technology is also called a base technology, which is commonly applied to various industries, such as transportation, information display, and architecture. Since the smart window technology induces quick state conversion by only simple operation, and provides various advanced convenient functions, it is expected to actively applied and developed for creating high value-added in automobiles.

A smart window used to be manufactured using polymer dispersed liquid crystal (Hereinafter, “PDLC”). In the PDLC, micron-sized liquid crystal particles are dispersed in polymer matrix, and light transmittance is controlled due to a refractive index difference between the liquid crystal particles and a polymer caused by an external voltage.

Referring to FIG. 1A, during an OFF state where voltage is not applied, liquid crystal particles are irregularly arranged, thereby light is scattered due to a refractive index difference with a polymer matrix. Referring to FIG. 1B, during an ON state where voltage is applied, the liquid crystal particles are regularly arranged to have the same refractive index with the polymer matrix and transmit the light. Light impermeability by scattering and light transmittance by applying voltage are important factors for determining performance of a smart window.

The PDLC using polymer matrix may cause hazing to the smart window. The PDLC has turbid color, and is hardened and altered when it is exposed to UV. Accordingly, the color of the smart window may change by yellowing.

Further, since most part of an electric field applied to the transparent electrode adjacent to the polymer matrix is shielded by induced polarization of the polymer due to a high dielectric constant of the polymer matrix, high driving voltage is necessary.

In general, the PDLC should be filled with the liquid crystal of about 50% or less level based on the entire smart window in order to prevent the liquid crystal from not forming a drop-shape and becoming bulky. Here, since an interface between the polymer matrix and the liquid crystal is not enough, a light blocking rate is low. Further, a driving voltage is increased further if a thickness becomes thicker in order to increase the interface.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with prior art.

An aspect of the present inventive concept provides a smart window using aerogel, which has a high porosity of 95% or more.

Another aspect of the present inventive concept provides a clean smart window, which has no yellowing and low haze value by using aerogel instead of using polymer matrix.

Still another aspect of the present inventive concept provides a smart window, which can control a refractive index of aerogel by adjusting a content ratio of Si and Ti in Si-Ti mixed aerogel.

The present disclosure is not limited to the above-described aspects, and other aspects and advantages of the present inventive concept that have not been described will be understood by the following description, and become apparent with reference to the embodiments of the present inventive concept. In addition, it will be appreciated that the aspects and advantages of the present inventive concept will be easily realized by means shown in the appended patent claims, and combinations thereof.

To achieve the above aspects, the present disclosure includes the following constituents.

According to an exemplary embodiment of the present inventive concept, a smart window includes a pair of transparent electrodes spaced apart to face each other. Porous aerogel is interposed between the pair of transparent electrodes. Liquid crystal is interposed between the transparent electrodes and fills pores of the aerogel.

The aerogel may have a porosity of 60% or more.

The aerogel may be silica aerogel or Si-Ti mixed aerogel.

A content ratio of Si and Ti in the Si-Ti mixed aerogel may vary to control a refractive index of the aerogel.

The content ratio of Si and Ti may be 1:1 to 10:1.

According to another exemplary embodiment of the present inventive concept, a method for manufacturing silica aerogel includes (a) manufacturing a mixed solution by mixing tetramethyl orthosilicate (TMOS) or tetraethyl orthosilicate (TEOS) with ammonia water (NH₄OH) and methanol; (b) coating the mixed solution on a transparent electrode; and (c) gelating the mixed solution by placing the coated transparent electrode under alcohol atmosphere.

According to still another exemplary embodiment of the present inventive concept, a method for manufacturing Si-Ti mixed aerogel includes (a) manufacturing a first solution by mixing tetraethoxysilane (TEOS) or methyltriethoxysilane (Me-TES), isopropyl alcohol and nitric acid; (b) manufacturing a second solution by mixing acetylacetone and Ti-acetylacetonate; (c) reacting the first solution and the second solution by mixing thereof; (d) coating the mixed solution of (c) on a transparent electrode; and (e) drying the transparent electrode coated with the mixed solution and then heating thereof.

Other aspects and exemplary embodiments of the inventive concept are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present inventive concept will now be described in detail with reference to certain exemplary embodiments thereof illustrated the accompanying drawings which are given hereinbelow by way of illustration only, and thus are not limitative of the present disclosure.

FIG. 1A and 1B are a schematic diagram illustrating structures of conventional PDLCs.

FIG. 2A and 2B are a schematic diagram illustrating structures of the smart windows using aerogel of the present disclosure.

FIG. 3 is a picture of the smart window containing silica aerogel, which is manufactured by one embodiment of the present inventive concept.

FIG. 4 is a picture of the Si-Ti mixed aerogel, which is manufactured by one embodiment of the present inventive concept.

FIG. 5 is a graph illustrating a cross-sectional profile along line AA of FIG. 4.

FIG. 6 is a picture of the smart window containing Si-Ti mixed aerogel, which is manufactured by one embodiment of the present inventive concept.

FIG. 7 is a picture showing enlarged liquid crystal droplets filled in pores of the Si-Ti mixed aerogel.

FIG. 8 is a graph illustrating the result of measuring transmittance of the smart window, which contains Si-Ti mixed aerogel with high Si content.

FIG. 9 is a graph illustrating the result of measuring transmittance of the smart window, which contains Si-Ti mixed aerogel with high Ti content.

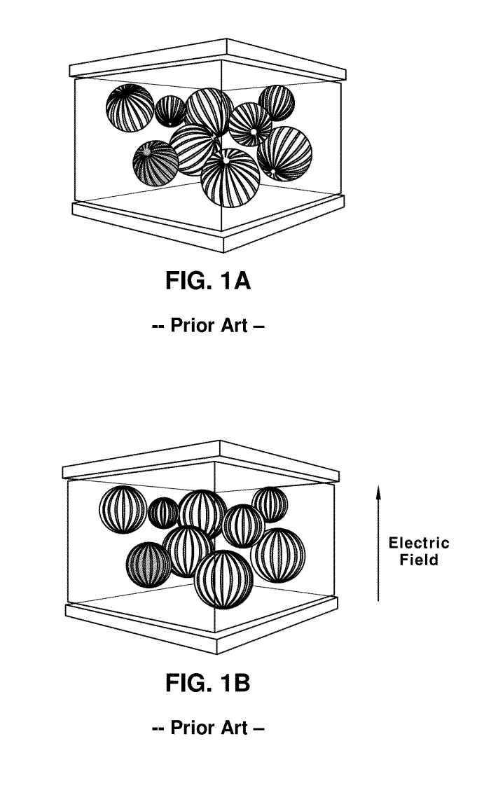

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents, and other embodiments, which may be included within the spirit and scope of the invention as defined by the appended claims.

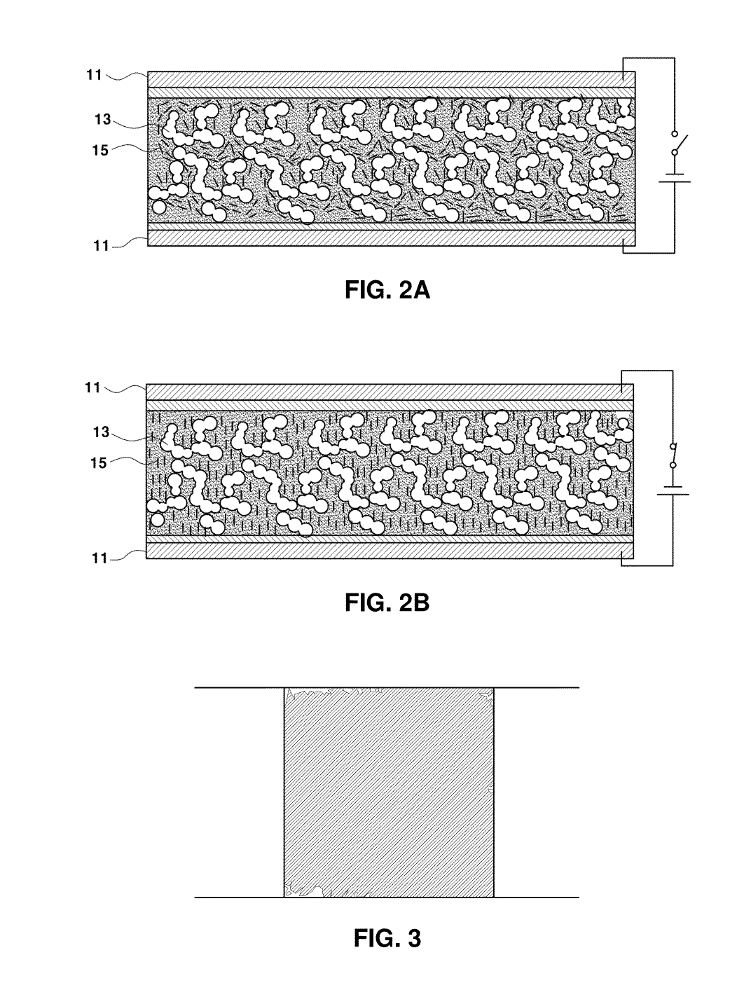

Referring to FIG. 2A and 2B, a smart window using aerogel according to the present disclosure may include a pair of transparent electrodes 11, which are separately arranged to face each other with a small interval. Porous aerogel 13 is interposed between the transparent electrodes 11. Liquid crystal 15 fills pores of the aerogel 13 and is interposed between the transparent electrodes 11.

The transparent electrodes 11 are glass or polyethylene terephthalate (PET) films coated with a transparent conductive thin film such as indium tin oxide (ITO), fluorine doped tin oxide (FTO) and the like, and are connected to an external power supply of the smart window. When it is in an ON state, an electric field is generated in a space between the transparent electrodes 11. The aerogel 13 can maximize a difference between transmittance and blocking of light due to its high porosity. As described above, the conventional polymer dispersed liquid crystal (PDLC) is filled with liquid crystal of 50% or less level. If more than 50% of liquid crystal is contained in the conventional PDLC, the liquid crystal does not form drop-shape and becomes bulky, thereby light transmittance and block cannot be effectively carried out.

On the contrary, the aerogel 13 has high porosity. Accordingly, when the liquid crystal 15 is filled in the space of the aerogel 13, an interface of the aerogel 13 and the liquid crystal 15 is maximized, and the liquid crystal 15 is grasped by the aerogel 13. Thus, the aerogel 13 can contain more liquid crystal 15 than the conventional PDLC, and have a uniform shape, size, and arrangement.

The porosity of the aerogel 13 may be 60% or more, or may be 95% or more because the aerogel 13 having the porosity of 60% or less cannot be filled with enough liquid crystal 15.

Further, as the interface of the aerogel 13 and the liquid crystal 15 increases, light scatters several times when it is introduced into the smart window during the OFF state, thereby increasing a light blocking rate. For example, the light may be refract at a 30-degree angle while passing the interface, and then refract at a 60-degree angle while passing the next interface, and the like. Accordingly, the light is refracted at a 90-degree angle or more, thereby preventing the light from being transmitted. Thus, a smart window having improved optical characteristics can be provided due to the difference between the light block on OFF state and the light transmittance during the ON state.

Further, since there are enough the interface formed between the aerogel 13 and the liquid crystal 15, the optical characteristics are further improved than the conventional PDLC, even when the thickness of the smart window is relatively thin. Accordingly, a thin smart window having a low driving voltage can be achieved.

The aerogel 13 has a very low thermal conductivity of about 0.03 W/m·K and a very high melting point of about 1,200° C., thus increasing mechanical and chemical stability.

Further, the aerogel 13 does not have yellowing, which occurs at polymer matrix, and has a low Haze value, thus providing a clean and high-grade smart window.

The aerogel 13 may be Silica (SiO₂) aerogel, which is the most commonly used material for aerogels, but it is not limited thereto, and it may be Si-Ti mixed aerogel.

The present disclosure can adjust the refractive index of the aerogel 13 by controlling a mixing ratio of Si and Ti of the Si-Ti mixed aerogel. Accordingly, the aerogel 13 can be used by matching the refractive index to various types of liquid crystal 15.

The Si-Ti mixing ratio may be in a range of 1:1 to 10:1. If the ratio is less than 1:1, the refractive index may become too high, thereby causing a big gap between the refractive index of the aerogel 13 and the refractive index of the liquid crystal 15. If the ratio is more than 10:1, the aerogel 13 may not mix well with the liquid crystal 15.

The liquid crystal 15 interacts with an electric field generated by the transparent electrodes 11, thereby actively transmitting or scattering the light. The liquid crystal 15 may be arranged parallel to an outer face of the aerogel 13, while forming the interface with the aerogel 13 in the OFF state without voltage applied thereto, thereby scattering the light. During the voltage-applied ON state, the liquid crystal 15 is arranged parallel to the electric field generated by the transparent electrodes 11, and has the same refractive index with the refractive index of the aerogel 13, thereby transmitting the light instead of scattering it.

The liquid crystal 15 may be coated on the transparent electrodes 11 after being mixed with the aerogel 13, absorbed to pores of the aerogel 13 by a capillary force. and then fixed after the aerogel 13 is coated on the transparent electrodes 11.

Hereinafter, the methods for manufacturing silica aerogel and Si-Ti mixed aerogel will be described in detail. In the present disclosure, the silica aerogel or the Si-Ti mixed aerogel is manufactured as a 1 to 10 μm-thick thin film.

The method for manufacturing the silica aerogel may include: (a) manufacturing a mixed solution by mixing tetramethyl orthosilicate (TMOS) or tetraethyl orthosilicate (TEOS) with ammonia water (NH₄OH) and methanol; (b) coating the mixed solution on a transparent electrode; and (c) gelating the mixed solution by placing the transparent electrode coated with the mixed solution under alcohol atmosphere.

The ammonia water is added as a catalyst to increase a gelation rate in step (C).

The coating may be conducted by spin coating, wire bar coating, doctor blade coating, and the like.

The gelation in the step (c) is conducted according to the following reaction formula 1.

Si(OCH₃)₄+2H₂O→SiO₂+4CH₃OH Reaction Formula 1

In the reaction of the above reaction formula 1, large pores are formed in the aerogel as alcohol is generated and evaporated.

The method for manufacturing the Si-Ti mixed aerogel may include: (a) manufacturing an A solution by mixing tetraethoxysilane (TEOS) or methyltriethoxysilane (Me-TES), isopropyl alcohol and nitric acid; (b) manufacturing a B solution by mixing acetylacetone and Ti-acetylacetonate; (c) reacting the A solution and the B solution by mixing thereof; (d) coating the mixed solution of (c) on a transparent electrode; and (e) drying the transparent electrode coated with the mixed solution and then heating thereof.

The drying in the step (e) is conducted in an airtight container under alcohol atmosphere to prevent cracks in the aerogel.

The aerogel manufactured by the above method has an advantage of having a high transmittance controlling range because liquid crystal is easily contained in the aerogel having large pores and high porosity.

### EXAMPLES

The following examples illustrate the disclosure and are not intended to limit the same.

### Example 1

### Manufacturing Smart Window Containing Silica Aerogel

(a) TMOS 3 ml, 0.069 mol % ammonia water 0.73 ml and methanol 1.8 ml were mixed to prepare a mixed solution.

(b) The mixed solution was spin coated on a transparent electrode.

(c) The transparent electrode coated with the mixed solution was dried for about 10 hours under alcohol atmosphere for gelation of the mixed solution.

(d) Another pair of transparent electrodes were bonded to an upper side of the gelation-completed silica aerogel, and liquid crystal was injected to the silica aerogel by capillary force to manufacture a smart window prototype.

### Example 2

### Manufacturing Smart Window Containing Si-Ti Mixed Aerogel

(a) 0.55 M TEOS 1.23 ml, 0.3 M Me-TES 0.565 ml, 0.4 M isopropyl alcohol 0.28 ml, and 0.343 M nitric acid 0.146 ml were mixed to prepare an A solution.

(b) 1 M acetylacetone 2.91 ml and 1 M Ti-acetylacetonate 1.04 ml were mixed to prepare a B solution.

(c) The A solution and the B solution were mixed and reacted for 2 hours.

(d) The mixed solution of the step (c) was stirred for 15 min, and then spin coated on a transparent electrode.

(e) The transparent electrode coated with the mixed solution was dried for 4 days in an airtight container under alcohol atmosphere, dried for 2 days in air, and then heated at 50° C. for 10 hours.

(f) Another pair of transparent electrodes were bonded to an upper side of the Si-Ti mixed aerogel, and liquid crystal was injected to the Si-Ti mixed aerogel by a capillary force to manufacture a smart window prototype.

### Measuring Example 1

### Light Block of Smart Window Containing Silica aerogel

FIG. 3 is a picture of the smart window containing silica aerogel, which is manufactured in Example 1. Light is scattered at an interface of the liquid crystal and the aerogel during the on OFF state where voltage is not applied to the transparent electrode, thereby maintaining an opaque condition.

### Measuring Example 2

### Surface Analysis of Si-Ti mixed aerogel

In order to analyze a surface of the Si-Ti mixed aerogel manufactured in Example 2, the pore structure was confirmed using an atomic force microscope (AFM).

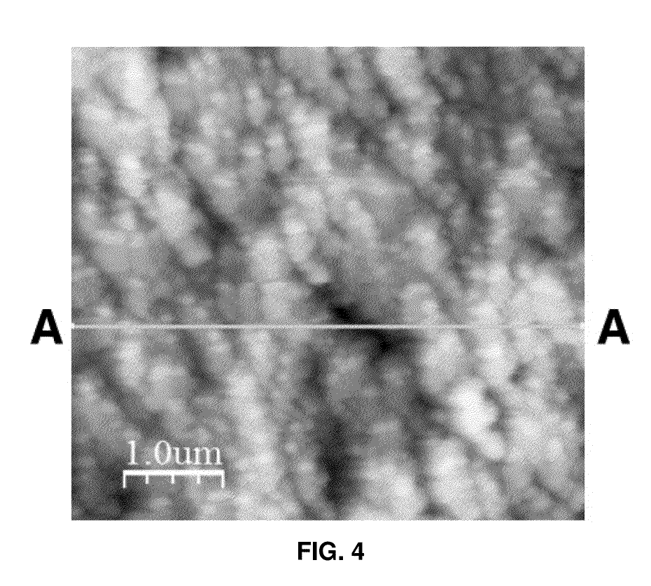

FIG. 4 is a picture of pores of the aerogel using the AFM, and a pore height is about 10 nm and a pore size is about 100 nm were observed.

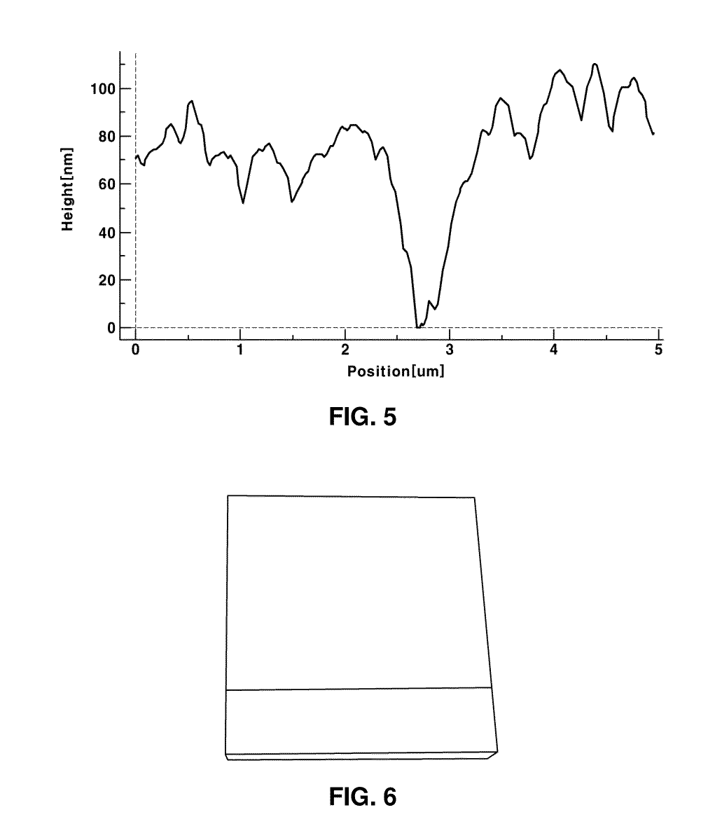

FIG. 5 is a graph illustrating a cross-sectional profile of the aerogel along the line AA of FIG. 4, in which the pores of the aerogel are evenly distributed.

According to Measuring Example 2, it could be confirmed that the Si-Ti mixed aerogel manufactured by the above manufacturing method forms a number of fine pores in a nanometer-level.

### Measuring Example 3

### Surface Analysis of Smart Window Containing Si-Ti Mixed Aerogel

FIG. 6 is a picture of the smart window containing Si-Ti mixed aerogel, which is manufactured in Example 2, in which the light is scattered at the interface of the liquid crystal and the aerogel during the on OFF state where voltage is not applied to the transparent electrode, thereby maintaining the opaque condition. Further, it could be confirmed that the smart window using the aerogel can realize clean and high-grade exterior due to its low haze value, compared with the conventional PDLC.

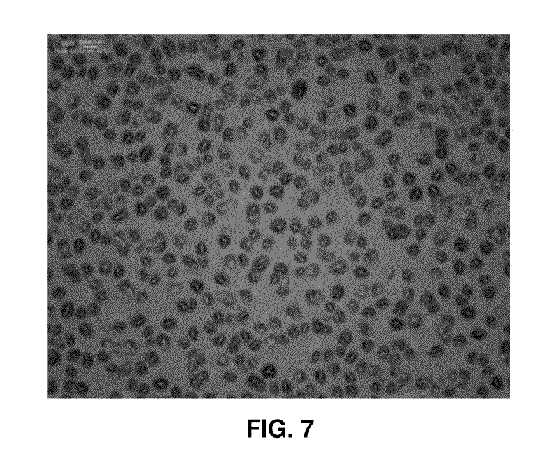

FIG. 7 is a picture showing 200 times enlarged liquid crystal droplets filled in pores of the Si-Ti mixed aerogel, and the liquid crystal droplets are about 10 μm in size. As shown in FIG. 7, it could be found that the liquid crystal can form constant size, shape, and arrangement by injecting the liquid crystal to the aerogel.

### Measuring Example 4

### Optical Characteristics of Smart Window Containing Si-Ti Mixed Aerogel

Transmittance of the smart window containing the Si-Ti mixed aerogel manufactured in Example 2 was manufactured using a spectral transmittance measuring device (Cary 5000 UV-Vis-NIR, Agilent).

As described above, the Si-Ti mixed aerogel can adjust the refractive index by controlling the mixing ratio of Si and Ti.

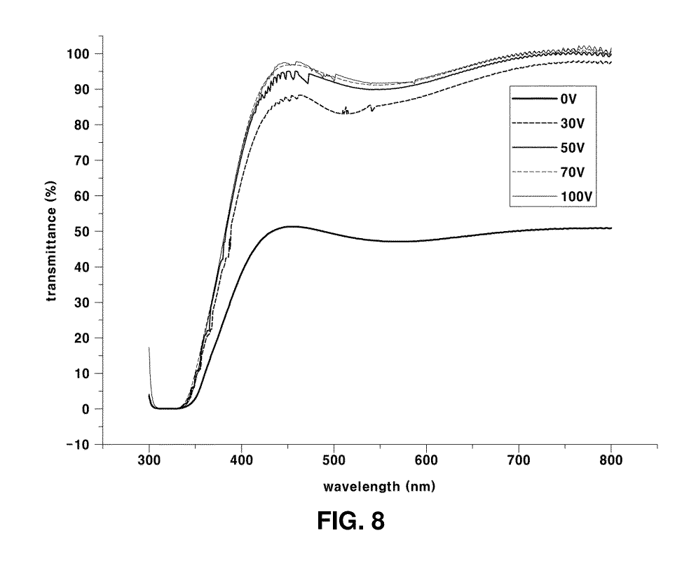

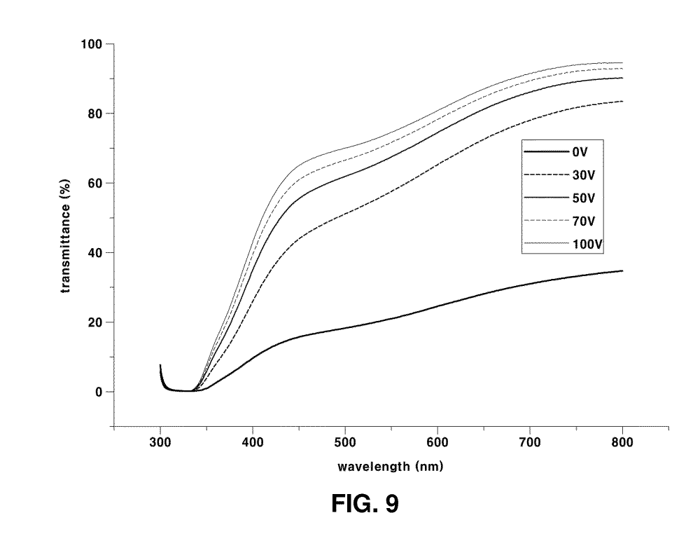

FIG. 8 is a graph illustrating results of measuring transmittance of a smart window, which contains Si-Ti mixed aerogel with high Si content (Si:Ti=1.65:1), and FIG. 9 is a graph illustrating results of measuring transmittance of a smart window, which contains Si-Ti mixed aerogel with high Ti content (Si:Ti=1.1:1). Transmittance was measured at driving voltage of 0, 30, 50, 70 and 100 V according to wavelength of light introduced into the smart window. The driving voltage means a voltage applied to the transparent electrode for generating an electric field at the smart window.

Referring to FIGS. 8 and 9, it could be found that the smart window transmits the light even at low driving voltage of 30 V due to its thin thickness. It could be confirmed that the smart window can function with very low driving voltage, compared with the PDLC which generally has driving voltage of 100 V.

Further, referring to FIG. 9, at a light wavelength of 600 nm, the smart window has transmittance of 22% during the OFF state (0 V), and transmittance of 65% during the ON state (30 V). Accordingly, it could be found that the smart window, which is commercially used, can be manufactured because the transmittance is largely different between the OFF state and the ON state.

Referring to FIG. 8, the prototype having the high Si content shows a high transmittance at a short wavelength range, and the overall transmittance is improved. Referring to FIG. 9, the prototype having the high Ti content shows a low transmittance at a short wavelength range, and the overall transmittance is reduced.

Accordingly, it could be confirmed that by controlling the content ratio of Si and Ti, the transmittance at each wavelength from the short wavelength to the long wavelength or the overall light transmittance can be controlled, and thus, a smart window having multiple functions can be manufactured.

The smart window according to the present disclosure uses aerogel having a very high porosity of 95% or more, and pores of the aerogel are filled with liquid crystal. Thus, it's the light blocking rate is high during the voltage OFF state because the interface between the aerogel and the liquid crystal is maximized, and therefore, light can be highly scattered. The smart window according to the present disclosure has a low driving voltage because the smart window does not need to be thickened to form more interfaces.

Since the smart window according to the present disclosure uses the aerogel instead of polymer matrix, clean and high-grade exterior can be realized due to its low haze value, thus preventing from yellowing.

Further, when manufacturing Si-Ti mixed aerogel, transmittance according to a wavelength range, the overall light transmittance and the like can be controlled by adjusting the content ratio of Si and Ti. Accordingly, the smart window of the present disclosure can be used for various purposes.

The smart window of the present disclosure uses porous aerogel and maximizes the interface between the aerogel and the liquid crystal, thereby scattering the light multiple times. Accordingly, a light blocking rate is improved.

The present disclosure maximizing the interface realizes enough light blocking rate even if the smart window has a thin thickness. Accordingly, a driving voltage decreases.

Further, the smart window according to the present disclosure using aerogel can provide mechanical and chemical stability.

In addition, the smart window according to the present invention using the aerogel instead of polymer matrix can provide a clean smart window with a low Haze value, thus preventing from yellowing.

Moreover, the smart window according to the present invention can control the refractive index of Si-Ti mixed aerogel to coincide with the refractive index of various types of liquid crystal.

The disclosure has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A smart window comprising:
a pair of transparent electrodes spaced apart to face each other;
porous aerogel interposed between the pair of transparent electrodes; and
liquid crystal interposed between the pair of transparent electrodes and filing pores of the aerogel.

2. The smart window of claim 1, wherein the aerogel has porosity of 60% or more.

3. The smart window of claim 1, wherein the aerogel is silica aerogel or silicon-titanium (Si-Ti) mixed aerogel.

4. The smart window of claim 3, wherein a content ratio of Si and Ti in the Si-Ti mixed aerogel varies to control a refractive index of the aerogel.

5. The smart window of claim 4, wherein the content ratio of Si and Ti is 1:1 to 10:1.

6. A method for manufacturing silica aerogel comprising:
(a) manufacturing a mixed solution by mixing tetramethyl orthosilicate (TMOS) or tetraethyl orthosilicate (TEOS) with ammonia water (NH₄OH) and methanol;
(b) coating the mixed solution on a transparent electrode; and
(c) gelating the mixed solution by placing the coated transparent electrode under alcohol atmosphere.

7. A method for manufacturing Si-Ti mixed aerogel comprising:
(a) manufacturing a first solution by mixing tetraethoxysilane (TEOS) or methyltriethoxysilane (Me-TES), isopropyl alcohol, and nitric acid;
(b) manufacturing a second solution by mixing acetylacetone and Ti-acetylacetonate;
(c) reacting the first solution and the second solution by mixing thereof;
(d) coating the mixed solution of (c) on a transparent electrode; and
(e) drying the transparent electrode coated with the mixed solution and then heating the transparent electrode.

8. A smart window comprises the silica aerogel manufactured by the method according to claim 6.

9. A smart window comprises the Si-Ti mixed aerogel manufactured by the method according to claim 7.
